(19) United States
(12) Patent Application Publication
(10) Pub. No.: US 2008/0180035 A1
(43) Pub. Date: Jul. 31, 2008

(54) Lighting string controller with universal power input

(76) Inventor: Ching Chi Cheng, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,772

(22) Filed: Jan. 30, 2008

(30) Foreign Application Priority Data
Jan. 30, 2007 (CN) 200720002856.8

(51) Int. Cl. H05B 37/00

(52) U.S. Cl. 315/186; 315/185 S

(57) ABSTRACT

A lighting string controller includes a power supply circuit that converts an alternate current (AC) input into a direct current (DC) output and includes an impedance buck circuit for expanding the applicable voltage range of the AC input and supplying a stable DC power to a display control circuit, a drive circuit and at least one lighting string. The display control circuit operates the lighting string through the drive circuit and the display control circuit controls time period within which the lighting string is in full lighting condition to allow a lighting string that is of a high power consumption to fully light in a short period of time. The display control circuit also functions to control operation modes of the lighting string, including lighting ON/OFF, interrupted lighting, gradually brightening/dimming, cyclic lighting, and alternating loop flashing, and can be controlled by a control switch or a remote control to switch among the operation modes. As such, a lighting string controller that is free of transformer and that is compact is size is realized.

### BACKGROUND OF THE INVENTION

1. Field of the Invention

The present invention relates to a lighting string controller with universal power input, and in particular to a lighting string controller that is applicable to a multiple-loop lighting string for controlling lighting operation thereof and that is capable to receive a wide range of alternate current input from for example an electric main.

2. The Related Arts

Lighting strings have been widely used in holiday celebrations and festivals. For example, the lighting string is arranged on for example a street tree or along opposite sides of a road to form a lighting tunnel. All these applications require an extremely long lighting string. Further, these long lighting strings are powered by direct current (DC) power sources and thus DC power supplies are required for the operation of the lighting strings. In addition, to control the lighting strings to light in a desired pattern or mode, a controller is needed to control lighting ON/OFF of the lighting strings. In this respect, the power supplies and the controllers are of vital importance for the operation of the lighting strings.

Conventionally, the lighting string is not subject to any limitation in power consumption so that the lighting string may be in a full lighting condition for a very long period of time. This consumes a great amount of power so that a large-capacity power supply is needed to ensure the amount of power required for operating the lighting string in a full lighting condition for a long period of time. This increases the overall power consumption of the power supply, which is not just a waste, but is also not environment conservative. In addition, such a large-capacity power supply requires a transformer that is often of a bulky size, occupying a large amount of space and causing problems in installation, especially for those consumers who wish to dynamically arrange the lighting string in any desired site.

Further, due the bulky transformer that is required for the large-capacity power supply used in the known lighting string, the overall size of the power supply gets larger, which is adverse to integration with the controller. Thus, in the conventional lighting string system, the controller and the power supply must be arranged separately. This causes troubles and inconveniences to the installation of the lighting string. In addition, a great length of wires is needed to connect between the power supply and the controller and this increases the chance that the power supply and the controller are subjected to high frequency electromagnetic interference to thereby influence the quality and stability of control of the lighting string. This is particularly true when the power supply and the controller are positioned outdoors.

To overcome such a problem of electromagnetic interference, conventionally, an anti-interference device or a high frequency filter is arranged between the power supply and the controller. This increases the overall cost for manufacturing and installation and also makes the overall size of the combination of power supply and controller bulky. This is further disadvantageous for outdoor operation and installation.

Further, the conventional lighting string controller must be installed in cooperation with the power supply and the installation thereof is subjected to the constraints imposed by the surroundings. For example, the lighting string may be arranged on a tower, and the controller provides only very monotonous control over the operation of the lighting strings, such as being totally lit or totally shut down and flashing. This prevents the user to control the lighting of the lighting string in any desired manner or any combination of different lighting modes. As a result, the lighting of the lighting string becomes very monotonous and dull.

Thus, it is desired to have a lighting string controller that overcomes the above discussed problems and drawbacks.

### SUMMARY OF THE INVENTION

An objective of the present invention is to provide a lighting string controller, which comprises a power supply circuit that is composed of an impedance buck circuit for expanding voltage range of an alternate current input power supplied thereto so that elimination of transformer employed in the conventional system is realized and the overall size can be reduced.

Another objective of the present invention is to provide a lighting string controller comprising an integrated device that combines a power supply circuit and a controller so that the length of electrical connection between the power supply circuit and the controller is reduced and a resonant circuit is further provided in the power supply circuit to eliminate the high frequency electromagnetic interference induced in the circuit.

A further objective of the present invention is to provide a lighting string controller comprising a display control circuit that operates the lighting string in plural operation modes including lighting ON/OFF, interrupted lighting, gradually brightening/dimming, cyclic lighting, and alternating loop flashing and automatically and/or cyclically switches among these operation modes.

Yet a further objective of the present invention is to provide a lighting string controller comprising a display control circuit that is operated by a control switch or a remote control to set the operation modes of the lighting string controlled by the display control circuit.

To achieve the above discussed objectives, in accordance with the present invention, a lighting string controller is provided, comprising a power supply circuit that converts an alternate current (AC) input into a direct current (DC) output and includes an impedance buck circuit for expanding the applicable voltage range of the AC input and supplying a stable DC power to a display control circuit, a drive circuit and at least one lighting string. The display control circuit operates the lighting string through the drive circuit and the display control circuit controls time period within which the lighting string is in full lighting condition to allow a lighting string that is of a high power consumption to fully light in a short period of time. The display control circuit also functions to control operation modes of the lighting string, including lighting ON/OFF, interrupted lighting, gradually brightening/dimming, cyclic lighting, and alternating loop flashing, and can be controlled by a control switch or a remote control to switch among the operation modes. As such, a lighting string controller that is free of transformer and that is compact is size is realized.

### BRIEF DESCRIPTION OF THE DRAWINGS

The present invention will be apparent to those skilled in the art by reading the following description of preferred embodiments thereof, with reference to the attached drawings, wherein:

FIG. 1 is a block diagram of a lighting string controller constructed in accordance with an embodiment of the present invention;

FIG. 2 is a detailed circuit diagram of the lighting string controller shown in FIG. 1;

FIG. 3 is a block diagram of a lighting string controller constructed in accordance with another embodiment of the present invention; and

FIG. 4 is a detailed circuit diagram of the lighting string controller shown in FIG. 3.

### DETAILED DESCRIPTION OF THE PREFERRED EMBODIMENTS

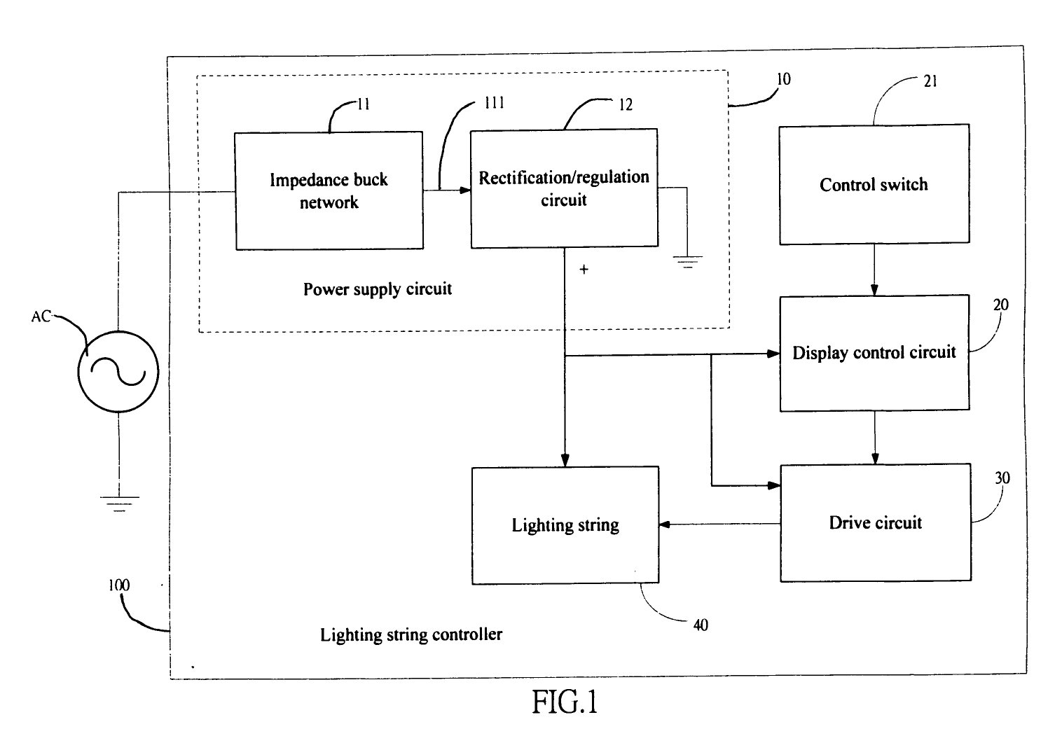

With reference to the drawings and in particular to FIG. 1, a lighting string controller 100 constructed in accordance with a first embodiment of the present invention features universal power input. The lighting string controller 100 comprises a power supply circuit 10, which converts an alternate current (AC) from for example an electric main into a direct current (DC) to provide a working power to other circuits or loads. The power supply circuit 10 comprises impedance buck network 11 and a rectification/regulation circuit 12. The impedance buck network 11 coverts an AC voltage from the electric main into a low voltage AC power 111. The rectification/regulation circuit 12 is connected to the impedance buck network 11 to convert the low voltage AC power 111 from the impedance buck network 11 into a stable DC working power so that the AC power from the electric main can be of a wide range of voltage, such as from AC 90V to AC 240V.

A display control circuit 20 provides functions of control and display of operation modes including lighting ON/OFF, interrupted lighting, gradually brightening/dimming, cyclic lighting, alternating loop flashing, and so on of the lighting string. The display and control function can be automatically and cyclically operated by the circuit itself, or manually operated or by a remote control. As shown in FIG. 1, the display control circuit 20 is connected with a control switch 21 and actuation of the control switch 21 switches the display control circuit 20 among different operation modes of lighting ON/OFF, interrupted lighting, gradually brightening/dimming, cyclic lighting, and alternating loop flashing.

A drive circuit 30 is connected to and driven by the display control circuit 20 to selectively activate the operation modes of lighting ON/OFF, interrupted lighting, gradually brightening/dimming, cyclic lighting, and alternating loop flashing. The drive circuit 30 is powered by electric power from the power supply circuit 10.

At least one lighting string 40 is connected to and driven by the drive circuit 30 for selectively operating in different modes including lighting ON/OFF, interrupted lighting, gradually brightening/dimming, cyclic lighting, and alternating loop flashing. The lighting string 40 is powered by electric power from the power supply circuit 10.

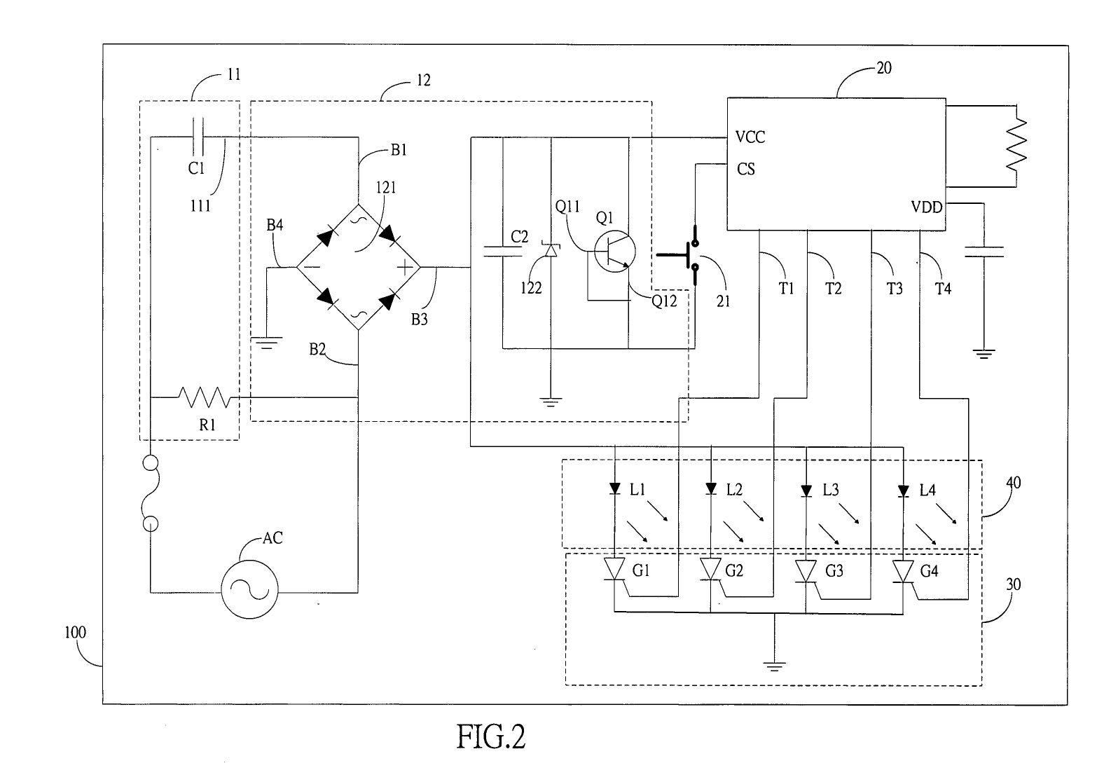

Also referring to FIG. 2, the circuit of the lighting string controller 100 of FIG. 1 is shown in detail and it is noted that the detailed circuit of FIG. 2 demonstrates an example of the present invention, and by no means imposes any limitation to the scope of the present invention. In the power supply circuit 10 shown in FIG. 1, the impedance buck circuit 11 is composed of a capacitor C1 and a resistor R1, which form a bucking impedance for AC power supply so that the AC voltage from the electric main is lowered to a level corresponding to the low voltage AC power source 111. The rectification/regulation circuit 12 is composed of a bridge rectifier 121, a capacitor C2, a Zener diode 122, and a transistor Q1. The bridge rectifier 121 has outputs B1, B2 respectively connected to the capacitor C1 and resistor R1 of the impedance buck circuit 11 and outputs B3, B4 respectively serving as positive and negative electrodes of the DC power supply to provide a regulated and stable DC power output. The capacitor C2, the Zener diode 122, and the transistor Q1 are connected in parallel with each other between the positive and negative terminals of the DC power supply. The capacitor C2 and the Zener diode 122 provide voltage regulation. The transistor Q1 has a base Q11 and an emitter Q12 to which the base Q11 is coupled so that reversed currents and noise induced in the power supply can be eliminated.

In the detailed circuit demonstrated in FIG. 2, the display control circuit 20 is embodied as a single-chip integrated circuit, but it is apparent that other equivalent circuits can replace the single-chip integrated circuit. The control display circuit 20 has power terminals VCC and VDD, which are respectively connected to the DC positive and negative terminals of the output terminals B3, B4 of the bridge rectifier 121 of the power supply circuit 10 to receive working power from the power supply circuit 10. The control display circuit 20 has a plurality of output control terminals T1, T2, T3, and T4, which supply display control signals to the drive circuit 30, and a switch control terminal CS, which receives a switching signal from the control switch 21. Additionally or alternately, the switch control terminal CS also functions to switch (preferably in a cyclic manner) among the different operation modes of the display control circuit 20 discussed above by the repetition of actuation (depression) of the control switch 21. An example of the switching operation is that when the control switch 21 is actuated the first time, the lighting string 40 is set in the lighting ON/OFF mode, and when the control switch 21 is actuated the second time, the lighting string 40 is set in for example the interrupted lighting mode, and so forth.

As show in FIG. 2, the drive circuit 30 is composed of a number of thyristors G1, G2, G3 and G4, which are embodied as silicon control rectifiers (SCRs) in the embodiment illustrated. The thyristors G1, G2, G3, and G4 have gates that are respectively connected to the output control terminals T1, T2, T3, and T4 of the display control circuit 20 for the control of triggering phases thereof to drive the lighting condition of the lighting string 40.

The lighting string 40, as shown in FIG. 2, comprises lighting elements that are arranged in four loops L1, L2, L3, and L4 and thus each lighting loop L1, L2, L3, L4 is composed of a number of lighting elements, such as light-emitting diodes and/or light bulbs connected to each other in a suitable arrangement. The lighting loops L1, L2, L3, L4 are respectively driven by the thyristors G1, G2, G3, G4 of the drive circuit 30 for controlled lighting in accordance with the different lighting modes discussed above, including lighting ON/OFF, interrupted lighting, gradually brightening/dimming, cyclic lighting, and alternating loop flashing. With such an arrangement, power consumption by the lighting elements and other components can be effectively controlled.

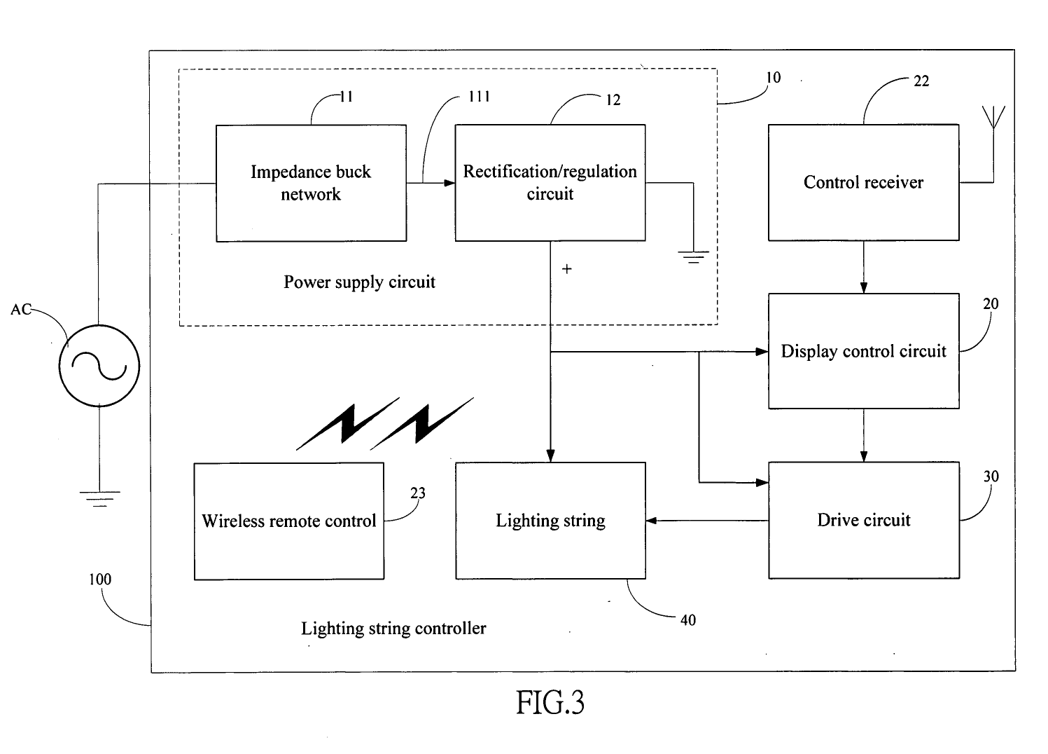

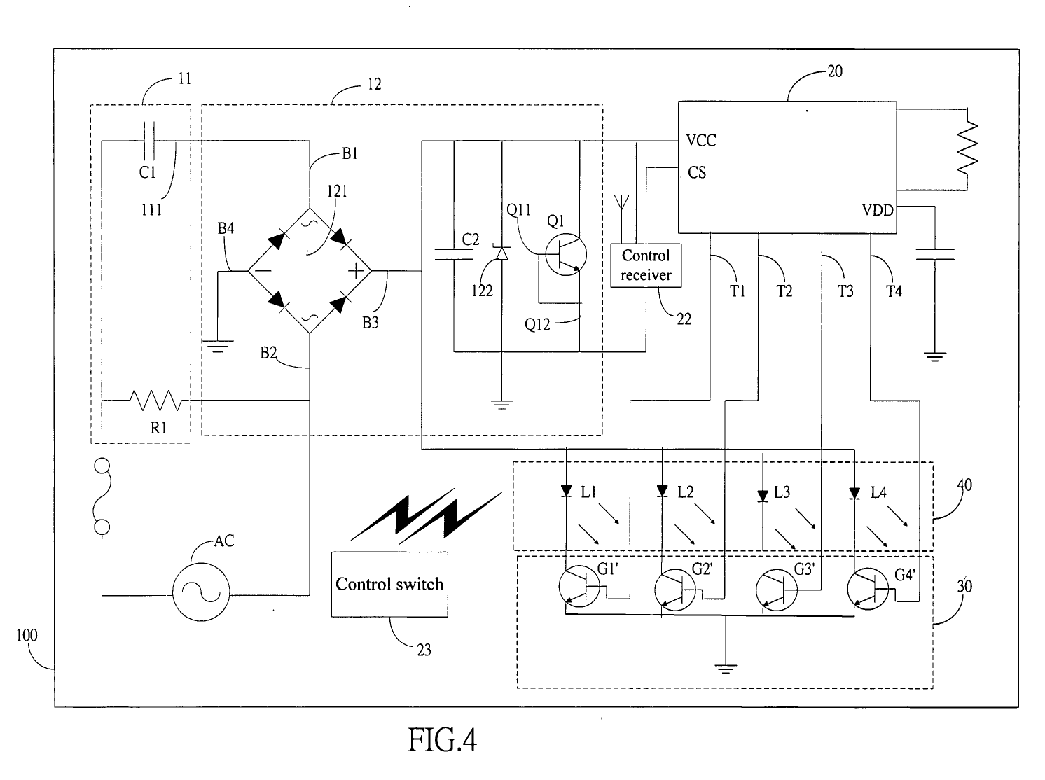

Also referring to FIGS. 3 and 4, a lighting string controller in accordance with another embodiment of the present invention, which is different from that shown in FIGS. 1 and 2, is provided, and is also designated with reference numeral 100 for simplicity. In the lighting string controller 100 of the second embodiment, a display control circuit 20, which functions substantially the same as the counterpart of the previous embodiment, has a switch control terminal CS that is connected to a wireless remote control receiver 22. The receiver 22 cooperates with a wireless remote control 23. The wireless remote control 23 functions to issue a remote control signal to control the wireless remote control receiver 22 to generate a switch control signal to the switch control terminal CS for controlling the operation modes of four lighting-element loops L1, L2, L3, L4, including lighting ON/OFF, interrupted lighting, gradually brightening/dimming, cyclic lighting, and alternating loop flashing. A drive circuit 30 comprises thyristors G1′, G2′, G3′, G4′, which are embodied by transistor elements and are applicable to low current driving applications for the lighting-element loops L1, L2, L3, L4.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lighting string controller, comprising:
a power supply circuit, which is adapted to connect to an external power source and comprises an impedance buck circuit that receives an input from the external power source and supplies an output of a low-voltage alternate current power and a rectification/regulation circuit that is connected to the impedance buck circuit to convert the low-voltage alternate current power into a direct current power serving as working power;
a display control circuit that functions to control of operation modes and comprises a switch control terminal that is adapted to receive a switch control signal for switching among the operation modes and a plurality of output control terminals that supply display control signals;
a drive circuit that is connected to the output control terminals of the display control circuit to receive the display control signals to be selectively set in the operation modes; and
at least one lighting string that is connected to the drive circuit to be driven by the drive circuit to operate in a selected one of the operation modes that the drive circuit is selectively set by the display control circuit.

2. The lighting string controller as claimed in claim 1, wherein the impedance buck circuit of the power supply circuit comprises a capacitor and a resistor.

3. The lighting string controller as claimed in claim 1, wherein the rectification/regulation circuit of the power supply circuit comprises:
a bridge rectifier, which has two terminals connected to the impedance buck circuit and two terminals serving as positive and negative terminals of the power supply circuit to provide the direct current power;
a capacitor and a Zener diode, which are connected in parallel to each other and between the positive and negative terminals of the power supply circuit to effect voltage regulation; and
a transistor, which is connected between the positive and negative terminals of the power supply circuit and which has a base and an emitter coupled to the base for eliminating reversed current and noise.

4. The lighting string controller as claimed in claim 1, wherein the display control circuit comprises a single-chip integrated circuit.

5. The lighting string controller as claimed in claim 1, wherein the switch control terminal of the display control circuit is connected to a control switch.

6. The lighting string controller as claimed in claim 1, wherein the switch control terminal of the display control circuit is connected to a wireless remote control receiver.

7. The lighting string controller as claimed in claim 1, wherein the driver circuit comprises a plurality of thyristors.

8. The lighting string controller as claimed in claim 7, wherein the thyristors comprise silicon control rectifiers.

9. The lighting string controller as claimed in claim 7, wherein the thyristors comprise transistors.

10. The lighting string controller as claimed in claim 1, wherein the at least one lighting string comprises multiple loops of lighting elements.

11. The lighting string controller as claimed in claim 10, wherein the lighting elements comprise light-emitting diodes.

12. The lighting string controller as claimed in claim 10, wherein the lighting elements comprise light bulbs.

13. The lighting string controller as claimed in claim 1, wherein the operation modes of lighting string settable by the display control circuit comprise lighting ON/OFF, interrupted lighting, gradually brightening/dimming, cyclic lighting, and alternating loop flashing.
